(19) United States
(12) Patent Application Publication
(10) Pub. No.: US 2022/0292281 A1
(43) Pub. Date: Sep. 15, 2022

(54) Loitering and Vagrancy Computer Vision Ai

(71) Applicant: Toniya Anthonipillai, Vaughan (CA)

(72) Inventor: Jeffery Zajac, Vaughan (CA)

(21) Appl. No.: 17/201,275

(22) Filed: Mar. 15, 2021

(51) Int. Cl. G06K 9/00; G06K 9/40

(52) U.S. Cl. CPC G06K 9/00342; G06K 9/00771; G06K 9/40

(57) ABSTRACT

A method for detecting a loitering event within an area of interest includes: capturing the human body entering into the area of interest; tracking the status of the human body; determining that the human body fails to be detected; obtaining the corresponding image data for the floor area based on the current time; determining that there is a blob in the corresponding image data; timing the duration of the blob in the floor area; detecting a loitering event when the duration exceeds a first predetermined threshold.

### TECHNICAL FIELD

The present invention relates to monitoring applications. In particular, the present invention relates to a method and apparatus for detecting a loitering event.

### BACKGROUND

The rising security concerns have led to an increase in the installation of video surveillance equipment for surveillance tasks. One of the demanding monitoring tasks is to detect a loitering event. Detection of a loitering event is crucial as loitering is related to harmful activities such as drug-dealing activity, scene investigation for robbery, and teenagers' unhealthy social problems wasting their time in the public area.

However, there are many false alerts sent out by the existing video surveillance equipment. The errors occur due to falsely identifying garbage on the floor, signs in the window, shadows created by dark and light, or missing a human body on the floor covered in sleeping bags and blankets or missing people remaining longer than the given time due to losing the track etc.

There is thus a need for improvements within this context.

### SUMMARY OF THE INVENTION

Given the above, it is thus an object of the present invention to overcome or mitigate the problems discussed above. In particular, it is an object to provide methods and apparatus that improve the detection of loitering events for various loitering behaviours and situations.

According to a first aspect of the invention, there is provided a method for detecting a loitering event within an area of interest, the method comprising the steps of:

capturing the human body entering into the area of interest;

tracking the status of the human body;

determining that the human body fails to be detected;

obtaining the corresponding image data for the floor area based on the current time;

determining that there is a blob in the corresponding image data;

timing the duration of the blob in the floor area; and

detecting a loitering event when the duration exceeds a first predetermined threshold.

According to some embodiments, obtaining the corresponding image data for the floor area based on the current time comprises:

getting a first image data for the floor area;

determining that the current time falls into the exception time;

eliminating the sunlight effect for the first image data and getting the processed image data; and

picking the processed image data as the corresponding image data.

According to some embodiments, after getting a first image data for the floor area the method further comprises:

determining that the current time doesn't fall into the exception time;

picking the first image data as the corresponding image data.

According to some embodiments, before capturing the human body entering into the area of interest the method further comprises:

getting the working hours of staff in the area of interest;

determining that the current time falls into the working hours;

pausing detecting the loitering event.

According to some embodiments, after tracking the status of the human body, the method further comprises:

determining that the human body is detected;

calculating the human body's duration of stay in the area of interest;

detecting the loitering event when the duration of stay exceeds a second predetermined threshold.

According to some embodiments, after determining that the human body fails to be detected, the method further comprises:

determining that the first human body is still in the area of interest; and

executing the step of obtaining the corresponding image data for the floor area based on the current time.

According to some embodiments, determining the human body is still in the area of interest comprises:

calculating the distance between the human body and the perimeter of the area of interest before the human body fails to be detected;

determining that the human body is still in the area of interest if the distance is greater than a third predetermined threshold.

According to a second aspect of the invention, the above object is achieved by an apparatus for detecting a loitering event within an area of interest, the apparatus comprises:

a first component configured to capture the human body entering into the area of interest;

a tracker configured to track the status of the human body;

a second component configured to determine that the human body fails to be detected;

an obtainer configured to obtain the corresponding image data for the floor area based on the current time;

a third component configured to determine that there is the blob in the corresponding image data;

a timer configured to time the duration of the blob in the floor area; and

a detector configured to detect a loitering event when the duration exceeds a first predetermined threshold.

According to some embodiments, the obtainer is further configured to: get a first image data for the floor area;

determine that the current time falls into the exception time;

eliminate the sunlight effect for the first image data and get the processed image data; and

pick the processed image data as the corresponding image data.

According to some embodiments, the apparatus further comprises a fourth component configured to:

determine that the current time doesn't fall into the exception time; and

pick the first image data as the corresponding image data.

According to some embodiments, the apparatus further comprises a controller configured to:

get the working hours of staff in the area of interest;

determine that the current time falls into the working hours; and

pause detecting the loitering event.

According to some embodiments, the apparatus further comprises a second detector configured to:

determine that the human body is detected;

calculate the human body's duration of stay in the area of interest; and

detect the loitering event when the duration of stay exceeds a second predetermined threshold.

According to some embodiments, the apparatus further comprises an executor configured to:

determine that the human body is still in the area of interest

[action?] decide if the human body fails to be detected; and

execute the step of obtaining the corresponding image data for the floor area based on the current time.

According to some embodiments, the executor is further configured to:

calculate the distance between the human body and the perimeter of the area of interest before the human body fails to be detected; and

determine the human body is still in the area of interest if the distance is greater than a third predetermined threshold.

According to a third aspect of the invention, the above object is achieved by a device adapted for detecting a loitering event, the device comprises a processor adapted for:

capturing the human body entering into the area of interest;

tracking the status of the first human body;

determining that the first human body fails to be detected;

obtaining the corresponding image data for the floor area based on the current time;

determining that there is the blob in the corresponding image data;

timing the duration of the blob in the floor area; and

detecting a loitering event when the duration exceeds a first predetermined threshold.

According to a fourth aspect of the invention, the above object is achieved by a computer program product, the computer program product comprising a non-transitory computer-readable storage medium with instructions adapted to carry out the method of the first aspect, when executed by a device having processing capability.

The second, third and fourth aspects may generally have the same features and advantages as the first aspect. It is further noted that the invention relates to all possible combinations of features unless explicitly stated otherwise.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference number will be used for similar elements, wherein:

FIG. 1 illustrates one example of the zone area for loitering event detection according to embodiments,

FIG. 2 illustrates another example of the floor area for loitering event detection according to embodiments,

FIG. 3 shows a flowchart of a method for detecting a loitering event according to embodiments,

FIG. 4 illustrates a structural configuration of a loitering event detection apparatus according to embodiments.

### DETAILED DESCRIPTION OF EMBODIMENTS

The present invention will now be described more fully hereinafter with reference to the accompanying drawings, in which embodiments of the invention are shown.

The following description and drawings are not intended to restrict the scope of the invention, and the scope of the invention should be defined by the appended claims. The terms used in the following description are merely used to describe particular embodiments of the invention and are not intended to limit the invention.

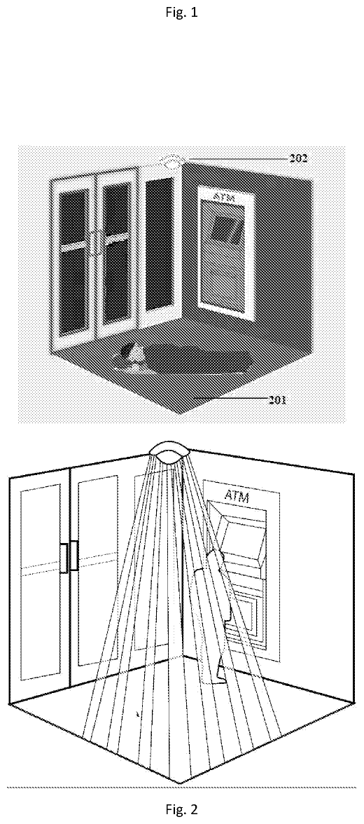

Basic loitering detection based on, e.g., a video stream captured by a camera, is known in the art. Known loitering detection is performed in the zone area. By “zone area” is generally meant the field of vision. Please refer to zone area 101 in FIG. 1 where zone area 101 includes the full human body. A human body is detected and tracked in the zone area. The time period that the human body is located within the defined area is commonly compared to a predetermined time period specified to detect a loitering event. However, there may be problems with this approach. Often, the detection of a human body is based on the movement of the human body. In case when the human body sleeps on the floor covered in sleeping bags or blankets, the tracking of the human body typically is lost. Please refer to FIG. 2. In FIG. 2, a human body sleeping on the floor covered in sleeping bags or blankets and floor area 201 is ignored.

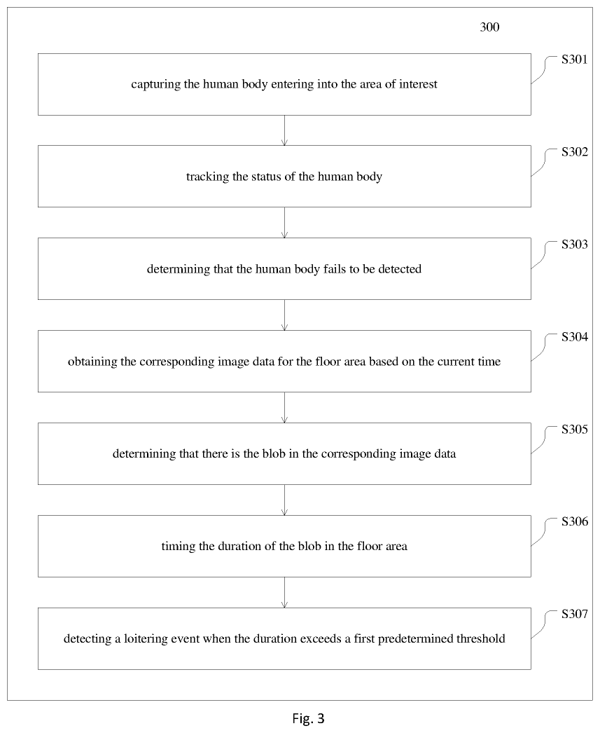

FIG. 3 is a flowchart of steps or processes in a method for detecting a loitering event within an area of interest.

A process 300 includes steps comprising: capturing the human body entering into the area of interest S301; tracking the status of the human body S302; determining that the human body fails to be detected S303; obtaining the corresponding image data for the floor area based on the current time S304; determining that there is the blob in the corresponding image data S305; timing the duration of the blob in the floor area S306; detecting a loitering event when the duration exceeds a first predetermined threshold S307. A blob is defined as a group of connected pixels in an image that share some common property (such as grayscale value). The status of a human body indicates the tracking status of a human body, e.g., the human body could be lost during the object tracking.

The process 300 could be executed in the apparatus for detecting a loitering event or other computing devices. In the following descriptions, the apparatus for detecting a loitering event is taken for example to describe.

In operation S301, the apparatus for detecting a loitering event captures the human body entering into the area of interest. By “area of interest” is generally meant to define an area within the monitored scene in which an object may be defined as a loitering object. In computer vision, there are many ways to capturing the human body entering the area of interest.

Haar cascade and HOG based approaches for human detection are early approaches for human body detection. The approach of the Haar cascade is widely used for Face Detection. OpenCV includes inbuilt functionality to provide Haar cascade based object detection. OpenCV is a library of programming functions mainly aimed at real-time computer vision. Pre-trained models provided by OpenCV for “Full Body Detection”, “Upper Body Detection” and “Lower Body Detection” are available. OpenCV includes inbuilt functionality to provide HOG based detection. It also includes a pre-trained model for Human Detection.

These two approaches are not very good at detecting the human body in various poses unless multiple models are used to detect the human body in each pose. Available pre-trained models with OpenCV are trained to identify the standing pose of a human body. They perform fairly well on detecting human bodies from the front view and back view. However, known detections from side views of human bodies are generally poor.

The breakthrough and rapid adoption of deep learning brought modern and highly accurate object detection algorithms and methods such as R-CNN, Fast-RCNN, Faster-RCNN, RetinaNet and fast yet highly accurate ones like SSD and YOLO. Using these methods and algorithms based on deep learning based on machine learning requires lots of mathematical and deep learning frameworks understanding. ImageAI is one of the python libraries with high detection accuracy based on deep learning. ImageAI can be used to capture the human body entering into the area of interest.

After the human body is captured, a unique ID is assigned to every human body entering into the area of interest by using a known centroid tracking algorithm. Afterwards, each of the human bodies is tracked with his associated IDs as they move around in the area of interest.

In operation S302, the apparatus for detecting a loitering event tracks the status of the human body. There are many sophisticated algorithms to track the object. Dlib's implementation of the correlation tracking algorithm is one of them. Dlib can be used to tracks the status of the human body. Centroid tracking is another algorithm which relies on the Euclidean distance between existing object centroids (i.e., objects the centroid tracker has already seen before) and new object centroids between subsequent frames in a video. Centroid is defined as the center of mass of a geometric object of uniform density. Both Dlib and centroid tracking can be used to tracks the status of the human body.

In operation S303, the apparatus for detecting a loitering event determines that the human body fails to be detected. In case when the human body sleeps on the floor covered in sleeping bags or blankets, the tracking of the human body typically is lost.

In operation S304, the apparatus for detecting a loitering event obtains the corresponding image data for the floor area based on the current time.

The current time is the time when the step of S304 is executed.

As an aspect of the invention, the apparatus for detecting a loitering event obtains the corresponding image data for the floor area based on the current time may be implemented by the following steps.

At first, the apparatus for detecting a loitering event gets the image data for the floor area. For example, in FIG. 2, the image data on the floor area 201 is taken by the camera 202. Floor area is a 2-dimensional notation, and it's the surface of the area of interest. In FIG. 2, floor area 201 is the floor surface of the ATM room.

Then the apparatus for detecting a loitering event determines that the current time falls into the exception time. The exception time is when the light and light shadows occurring in the area are monitored. For example, at 1:00 pm, the sun shines brightly into the south-facing window. But at 9 am, the sun shines brightly into the east window. This causes light streams on the floor, causing AI algorithms to see a blob because of the colour difference. It should be noted that the exception time is not fixed. The exception time could be changed according to season and weather. For instance, if the exception time is from 10:00 am to 1:00 pm, the current time 10:30 am falls into the exception time. And if the exception time is from 10:00 am to 1:00 pm, the current time at 2:30 pm doesn't fall into the exception time.

Next, the apparatus for detecting a loitering event eliminates the sunlight effect for the first image data. In OpenCV, the image absolute difference can be used to eliminate the sunlight effect. And then get the processed image data. The processed image data is the image data where the sunlight effect is reduced from the first image data. There are no light streams on the floor in the processed image data, as will not cause AI algorithms to see a blob.

Finally, the apparatus for detecting a loitering event picks the processed image data as the corresponding image data. The processed image data will be used as the corresponding image data in the following steps.

As an aspect of the invention, the apparatus for detecting a loitering event determines that the current time doesn't fall into the exception time; and picks the first image data as the corresponding image data.

If the current time doesn't fall into the exception time, then the apparatus determines the first image data as the corresponding image data. For example, if the exception time is from 10:00 am to 3:00 pm, the current time 6:30 pm doesn't fall into the exception time. It's not necessary to reduce the sunlight effect in the first image data in this case. Just the first image data is picked as the corresponding image data.

As an aspect of the invention, the apparatus for detecting a loitering event gets the working hours of staff in the area of interest, determines that the current time falls into the working hours, and pauses detecting the loitering event.

The working hours of staff in the area of interest may be the cleaner's working hours. For example, the cleaners always clean the area of interest at a certain time of day. Cleaners could leave garbage bags in the area of interest. Consequently, the garbage bag could lead to a false alert. To avoid unnecessary false alerts, the loitering event's detection could be paused during the working hours of staff.

As an aspect of the invention, after tracking the status of the human body, the apparatus for detecting a loitering event determines that the human body is detected, calculates the human body's duration of stay in the area of interest and detects a loitering event when the stay exceeds a second predetermined threshold.

The apparatus can judge whether the human body can be detected. This can be implemented by using the related tracking methods in OpenCV. If the apparatus determines that the human body is detected, it calculates the human body's duration of stay in the area of interest by using a timer. Finally the apparatus detects a loitering event when the stay exceeds a second predetermined threshold. For example, the second predetermined threshold could be 20 minutes. If the human body's duration of stay in the area of interest is 40 minutes, then a body alert can be sent to the server-side because the stay exceeds a second predetermined threshold. Security personnel could be assigned to the area of interest after the server-side receives the body alert. If the human body's duration of stay in the area of interest is 10 minutes, then it's unnecessary to send a body alert to the sever-side because the stay doesn't exceed a second predetermined threshold.

As an aspect of the invention, the apparatus for detecting a loitering event determines that the human body is still in the area of interest by executing the following steps.

At first, the apparatus for detecting a loitering event gets the human body's location information before the human body fails to be detected. For example, there are 20 consecutive video frames for tracking at least one human body. The human body can be detected in the first 15 consecutive video frames. Starting from the 16th video frame, the human body fails to be detected. Then the human body's location information in the 15th video frame is the human body's location information before the human body fails to be detected.

Next, the apparatus for detecting a loitering event calculates the distance between the human body and the perimeter of the area of interest before the human body fails to be detected. Here the perimeter of the area of interest is defined as the outside edge of the area of interest. The perimeter of the area of interest may be a rectangle. In OpenCV, there are ways to calculate the distance between objects. In the 15th video frame, the distance between the human body and the perimeter of the area of interest may be calculated by the related OpenCV methods.

Finally, the apparatus for detecting a loitering event determines that the human body is still in the area of interest if the distance is greater than a third predetermined threshold. For example, the third predetermined threshold could be 10 centimetres. If the distance is 20 centimetres, then the apparatus for detecting a loitering event determines that the human body is still in the area of interest. If the distance is 5 centimetres, then the apparatus for detecting a loitering event determines that the human body is not in the area of interest.

As an aspect of the invention, if the human body fails to be detected, the apparatus for detecting a loitering event determines that the human body is still in the area of interest and executes the step of obtaining the corresponding image data for the floor area based on the current time.

The apparatus for detecting a loitering event could judge whether the human body is still in the area of interest at first. If the human body is still in the area of interest, then obtaining the corresponding image data for the floor area based on the current time is executed. If the human body is not in the area of interest, then obtaining the corresponding image data for the floor area based on the current time is not executed. The apparatus for detecting a loitering event considers that human body already left the area of interest, and restarts to execute capturing the human body entering into the area of interest in this case.

In operation S305, the apparatus for detecting a loitering event determines that there is the blob in the corresponding image data.

A blob is a group of connected pixels in an image that share some common property (such as grayscale value). OpenCV provides convenient ways to detect blobs and filter them based on different characteristics.

In operation S306, the apparatus for detecting a loitering event times the duration of the blob in the floor area.

A software timer could be started to time the duration of the blob in the floor area after the apparatus found that there is the blob in the corresponding image data.

In operation S307, the apparatus for detecting a loitering event detects a loitering event when the duration exceeds a first predetermined threshold.

The first predetermined threshold could be 15 minutes or any other assigned time value. When the duration of the blob in the floor area exceeds a first predetermined threshold, the apparatus may identify that the blob could be a human body or garbage. The apparatus could send a blob alert to the server-side. After receiving the blob alert, the security personnel could be assigned to the area of interest to investigate.

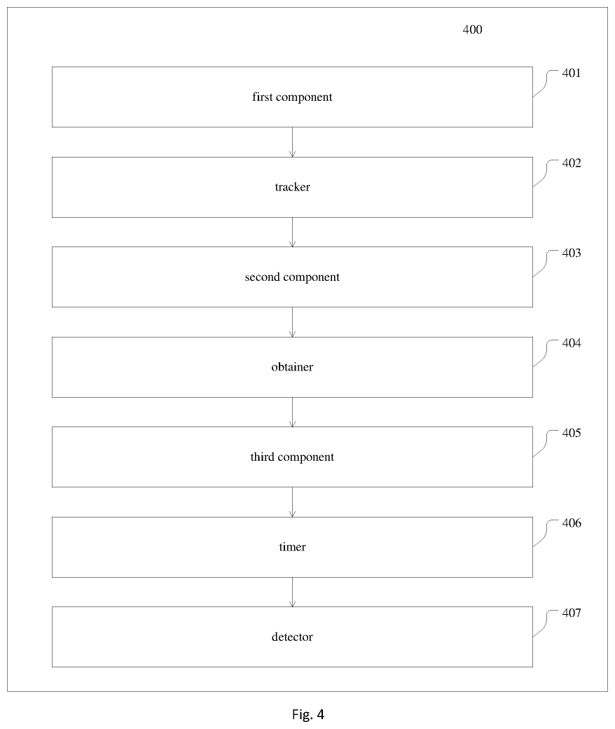

FIG. 4 illustrates a structural configuration of a loitering event detection apparatus, according to an exemplary embodiment.

The apparatus 400 includes a first component 401, a tracker 402, a second component 403, an obtainer 404, a third component 405, a timer 406, and a detector 407.

The first component 401 captures at least one human body entering into the area of interest, by using a loitering event detection method. By “area of interest” is generally meant to define an area within the monitored scene in which an object may be defined as a loitering object. In computer vision, there are many ways to capturing the human body entering the area of interest.

The breakthrough and rapid adoption of deep learning brought modern and highly accurate object detection algorithms and methods such as R-CNN, Fast-RCNN, Faster-RCNN, RetinaNet and fast yet highly accurate ones like SSD and YOLO. Using these methods and algorithms based on deep learning based on machine learning requires lots of mathematical and deep learning frameworks understanding. ImageAI is one of the python libraries with high detection accuracy based on deep learning. ImageAI can be used in the first component 401 to capture the human body entering into the area of interest.

After the human body is captured, a unique ID is assigned to every human body entering into the area of interest by using a known centroid tracking algorithm. Afterwards, each of the human bodies is tracked by the apparatus with his associated IDs as they move around in the area of interest.

The tracker 402 tracks the status of the human body.

There are many sophisticated algorithms to track the object. Dlib's implementation of the correlation tracking algorithm is one of them. Dlib can be used to tracks the status of the human body. Centroid tracking is another algorithm which relies on the Euclidean distance between existing object centroids (i.e., objects the centroid tracker has already seen before) and new object centroids between subsequent frames in a video. Centroid is defined as the center of mass of a geometric object of uniform density. Both Dlib and centroid tracking can be used in tracker 402 to track the status of the human body.

The second component 403 determines that the human body fails to be detected. In case when the human body sleeps on the floor covered in sleeping bags or blankets, the tracking of the human body typically is lost.

The obtainer 404 obtains the corresponding image data for the floor area based on the current time. The current time is the time when obtaining the corresponding image data for the floor area.

As an aspect of the invention, the obtainer 404 may implement the following steps.

At first, the obtainer 404 gets the image data for the floor area. For example, in FIG. 2, the image data on the floor area 201 is taken by the camera 202. Floor area is a 2-dimensional notation, and it's the surface of the area of interest. In FIG. 2, floor area 201 is the floor surface of the ATM room.

Then the obtainer 404 determines that the current time falls into the exception time. The exception time is when the light and light shadows occurring in the area are monitored. For example, at 1:00 pm, the sun shines brightly into the south-facing window. But at 9 am, the sun shines brightly into the east window. This causes light streams on the floor, causing AI algorithms to see a blob because of the colour difference. It should be noted that the exception time is not fixed. The exception time could be changed according to season and weather. For instance, if the exception time is from 10:00 am to 1:00 pm, the current time 10:30 am falls into the exception time. And if the exception time is from 10:00 am to 1:00 pm, the current time at 2:30 pm doesn't fall into the exception time.

Next, the obtainer 404 eliminates the sunlight effect for the first image data. In OpenCV, the image absolute difference can be used to eliminate the sunlight effect. And then get the processed image data. The processed image data is the image data where the sunlight effect is reduced from the first image data. There are no light streams on the floor in the processed image data, and the sunlight effect will not cause AI algorithms to see a blob.

Finally, the obtainer 404 picks the processed image data as the corresponding image data. The processed image data will be used as the corresponding image data in the following steps.

Additionally, the apparatus 400 may include a fourth component. The fourth component determines that the current time doesn't fall into the exception time; and picks the first image data as the corresponding image data.

If the current time doesn't fall into the exception time, then fourth component determines the first image data as the corresponding image data. For example, if the exception time is from 10:00 am to 3:00 pm, the current time 6:30 pm doesn't fall into the exception time. It's not necessary to reduce the sunlight effect in the first image data in this case. Just the first image data is picked as the corresponding image data.

Additionally, the apparatus 400 may include a controller. The controller improves the efficiency of the invention by accounting for the working hours of staff. The controller gets the working hours of staff in the area of interest, determines that the current time falls into the working hours, and pauses detecting the loitering event.

The working hours of staff in the area of interest may be the cleaner's working hours. For example, the cleaners always clean the area of interest at a certain time of day. Cleaners could leave garbage bags in the area of interest. Consequently, the garbage bag could lead to a false alert. To avoid unnecessary false alerts, the loitering event's detection could be paused during the working hours of staff.

Additionally, the apparatus 400 may include a second detector. The second detector improves the efficiency of the invention by judging the human body's duration of stay. The second detector determines that the human body can be detected, calculates the human body's duration of stay in the area of interest and detects a loitering event when the stay exceeds a second predetermined threshold.

The second detector can judge whether the human body can be detected. This can be implemented by using the related tracing methods in OpenCV. If the second detector determines that the human body is detected, it calculates the human body's duration of stay in the area of interest by using a timer. Finally the second detector detects a loitering event when the stay exceeds a second predetermined threshold. For example, the second predetermined threshold could be 20 minutes. If the human body's duration of stay in the area of interest is 40 minutes, then a body alert can be sent to the server-side because the stay exceeds a second predetermined threshold. Security personnel could be assigned to the area of interest after the server-side receives the body alert. If the human body's duration of stay in the area of interest is 10 minutes, then it's unnecessary to send a body alert to the sever-side because the stay doesn't exceed a second predetermined threshold.

Additionally, the apparatus 400 may include an executor. The executor improves the efficiency of the invention by using additional threshold and distance when a human body fails to be detected. The executor determines that the human body is still in the area of interest; and obtains the corresponding image data for the floor area based on the current time.

The executor could judge whether the human body is still in the area of interest at first. If the human body is still in the area of interest, then the executor obtains the corresponding image data for the floor area based on the current time is executed. If the human body is not in the area of interest, then the apparatus 400 considers that human body already left the area of interest, and restarts to execute capturing the human body entering into the area of interest in this case.

The executor may execute the following steps to judge whether the human body is still in the area of interest.

At first, the executor gets the human body's location information before the human body fails to be detected. For example, there are 20 consecutive video frames for tracking at least one human body. The human body can be detected in the first 15 consecutive video frames. Starting from the 16th video frame, the human body fails to be detected. Then the human body's location information in the 15th video frame is the human body's location information before the human body fails to be detected.

Next, the executor calculates the distance between the human body and the perimeter of the area of interest before the human body fails to be detected. Here the perimeter of the area of interest is defined as the outside edge of the area of interest. The perimeter of the area of interest may be a rectangle. In OpenCV, there are ways to calculate the distance between objects. In the 15th video frame, the distance between the human body and the perimeter of the area of interest may be calculated by the related OpenCV methods.

Finally, the executor determines that the human body is still in the area of interest if the distance is greater than a third predetermined threshold. For example, the third predetermined threshold could be 10 centimetres. If the distance is 20 centimetres, then the apparatus for detecting a loitering event determines that the human body is still in the area of interest. If the distance is 5 centimetres, then the apparatus for detecting a loitering event determines that the human body is not in the area of interest.

The third component 405 determines that there is the blob in the corresponding image data. A blob is a group of connected pixels in an image that share some common property (such as grayscale value). OpenCV provides convenient ways to detect blobs and filter them based on different characteristics.

The timer 406 aims to time the duration of the blob in the floor area. A software timer could be started to time the duration of the blob in the floor area after the apparatus found that there is the blob in the corresponding image data in the timer.

The detector 407 detects a loitering event when the duration exceeds a first predetermined threshold. The first predetermined threshold could be 15 minutes or any other assigned time value. When the duration of the blob in the floor area exceeds a first predetermined threshold, the apparatus may identify that the blob could be a human body or garbage. The apparatus could send a blob alert to the server-side. After receiving the blob alert, the security personnel could be assigned to the area of interest to investigate.

Besides, the above exemplary embodiments can also be implemented through computer-readable code/instructions in/on a medium, e.g., a computer-readable medium, to control at least one processing element to implement any above-described embodiment. The medium can correspond to any medium/media permitting the computer-readable code's storage and/or transmission.

The computer-readable code can be recorded/transferred on a medium in a variety of ways, with examples of the medium including recording media, such as magnetic storage media (e.g., ROM, hard disk, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network so that the computer-readable code is stored/transferred and executed in a distributed fashion. Furthermore, the processing element could include a processor or a computer processor, and processing elements may be distributed and/or included in a single device.

At least one of the components represented by a block, as illustrated in FIG. 4, may be embodied as various numbers of hardware, software and/or firmware structures that execute respective functions described above, according to an exemplary embodiment. For example, at least one of these components may use a direct circuit structure, such as a memory, processing, logic, a look-up table, etc. that may execute the respective functions through controls of one or more microprocessors or other control apparatuses. Also, at least one of these components may be specifically embodied by a module, a program or a part of code, which contains one or more executable instructions for performing specified logic functions, and executed by one or more microprocessors other control apparatuses. Also, at least one of these components may further include a processor such as a central processing unit (CPU) that performs the respective functions, a microprocessor, or the like. Two or more of these components may be combined into one component, element or unit, which performs all operations or functions of the combined two or more components, elements or units. Also, at least part of the functions of at least one of the components may be performed by another of these components.

It should be understood that the exemplary embodiments described therein should be considered in a descriptive sense only and not for the limitation. Descriptions of features or aspects within each embodiment should typically be considered as available for other similar features or aspects in other embodiments.

While a plurality of exemplary embodiments has been described regarding the drawings, it will be understood by those of ordinary skill in the art that various changes in form and details may be made therein without departing from the spirit and scope of the invention as defined by the following claims.

1. A method for detecting a loitering event within an area of interest, the method comprising:
capturing the human body entering into the area of interest;
tracking the status of the human body;
determining that the human body fails to be detected;
obtaining the corresponding image data for the floor area based on the current time;
determining that there is a blob in the corresponding image data;
timing the duration of the blob in the floor area; and
detecting a loitering event when the duration exceeds a first predetermined threshold.

2. The method of claim 1, wherein obtaining the corresponding image data for the floor area based on the current time comprises:
getting a first image data for the floor area;
determining that the current time falls into the exception time;
eliminating the sunlight effect for the first image data and getting the processed image data; and
picking the processed image data as the corresponding image data.

3. The method of claim 2, after getting a first image data for the floor area further comprising:
determining that the current time doesn't fall into the exception time; and
picking the first image data as the corresponding image data.

4. The method of claim 1, before capturing the human body entering into the area of interest further comprising:
getting the working hours of staff in the area of interest;
determining that the current time falls into the working hours; and
pausing detecting the loitering event.

5. The method of claim 1, wherein after tracking the status of the human body, the method further comprising:
determining that the human body is detected;
calculating the human body's duration of stay in the area of interest;
detecting the loitering event when the duration of stay exceeds a second predetermined threshold.

6. The method of 1, wherein after determining that the human body fails to be detected, the method further comprising:
determining that the human body is still in the area of interest; and
executing the step of obtaining the corresponding image data for the floor area based on the current time.

7. The method of claim 6, wherein the step of determining that the human body is still in the area of interest comprises:
calculating the distance between the human body and the perimeter of the area of interest before the human body fails to be detected; and
determining that the human body is still in the area of interest if the distance is greater than a third predetermined threshold.

8. An apparatus for detecting a loitering event within an area of interest, the apparatus comprising:
a first component configured to capture the human body entering into the area of interest;
a tracker configured to track the status of the human body;
a second component configured to determine that the human body fails to be detected;
an obtainer configured to obtain the corresponding image data for the floor area based on the current time;
a third component configured to determine that there is the blob in the corresponding image data;
a timer configured to time the duration of the blob in the floor area; and
a detector configured to detect a loitering event when the duration exceeds a first predetermined threshold.

9. The apparatus of claim 8, wherein the obtainer is further configured to:
get a first image data for the floor area;
determine that the current time falls into the exception time;
eliminate the sunlight effect for the first image data and get the processed image data; and
pick the processed image data as the corresponding image data.

10. The apparatus of claim 9, further comprising a fourth component configured to:
determine that the current time doesn't fall into the exception time; and
pick the first image data as the corresponding image data.

11. The apparatus of claim 8, further comprising a controller configured to:
get the working hours of staff in the area of interest;
determine that the current time falls into the working hours; and
pause detecting the loitering event.

12. The apparatus of claim 8, further comprising a second detector configured to:
determine that the human body is detected;
calculate the human body's duration of stay in the area of interest;
detect the loitering event when the duration of stay exceeds a second predetermined threshold.

13. The apparatus of claim 8, further comprising an executor configured to:
determine that the human body is still in the area of interest if the human body fails to be detected; and
execute the step of obtaining the corresponding image data for the floor area based on the current time.

14. The apparatus of claim 13, the executor is further configured to:
calculate the distance between the human body and the perimeter of the area of interest before the human body fails to be detected; and
determine the human body is still in the area of interest if the distance is greater than a third predetermined threshold.

15. A computer program product comprising a non-transitory computer-readable storage medium with instructions adapted to carry out the method of claim 1, when executed by a device having processing capability.
